(19) United States
(12) Patent Application Publication
(10) Pub. No.: US 2012/0202512 A1
(43) Pub. Date: Aug. 9, 2012

(54) DATA THROUGHPUT FOR CELL-EDGE USERS IN A LTE NETWORK USING ALTERNATIVE POWER CONTROL FOR UP-LINK HARQ RELAYS

(76) Inventor: RICHARD NEIL BRAITHWAITE, ORANGE, CA (US)

(21) Appl. No.: 13/365,109

(22) Filed: Feb. 2, 2012

Related U.S. Application Data
(60) Provisional application No. 61/439,551, filed on Feb. 4, 2011.

(51) Int. Cl. H04W 52/26; H04W 72/04

(52) U.S. Cl. 455/452.2; 455/522

(57) ABSTRACT

It is proposed that alternative power control be used to improve the data throughput for user equipment (UE) in a LTE network having up-link relays. In this alternative power control scheme, every UE is assigned a maximum transmit power and a maximum modulation coding rate. Fair power control is applied only when the maximum modulation coding rate is achieved. Simulations indicate that a network having up-link relays and UEs having alternative power control improves the average throughput significantly.

### RELATED APPLICATION INFORMATION

The present application claims priority under 35 U.S.C. Section 119(e) to U.S. Provisional Patent Application Ser. No. 61/439,551 filed Feb. 4, 2011, the disclosure of which is incorporated herein by reference in its entirety.

### BACKGROUND OF THE INVENTION

1. Field of the Invention

The present invention relates in general to radio communication systems for wireless networks. More particularly, the invention is directed to cellular networks employing up-link relays.

2. Description of the Prior Art and Related Background Information

Modern wireless communication systems typically employ a base station communicating with mobile devices or user equipment. The user equipment may adjust the transmission power in order to maintain a sufficient signal-to-noise ratio for the signal received at the base station. Recently, relays have been suggested as a means for improving the data throughput for the user equipment. However, traditional power control algorithms may not achieve optimal data throughput.

Accordingly, a need exists to improve the power control for user equipment in networks employing relays.

### SUMMARY OF THE INVENTION

In a first aspect, the present invention provides a wireless communication system, comprising a base station communicating within a cell, the base station comprising a module controlling resource allocation for up-link and down-link signals. The system further comprises user equipment located within the cell, the user equipment transmitting and receiving signals. The base station determines a data throughput of the up-link signal of the user equipment and determines a user equipment modulation coding rate and a user equipment transmission power and transmits adjustments to the user equipment modulation coding rate and adjustments to the user equipment transmission power to the user equipment based on the data throughput.

In a preferred embodiment, the wireless communication system preferably further comprises an up-link relay receiving the up-link signals, decoding the received up-link signals, recoding the decoded up-link signals, and re-transmitting the recoded up-link signals. The base station preferably comprises a scheduler for determining the data throughput of the up-link signal of the user equipment, where the scheduler determines the adjustments to the user equipment modulation coding rate and the adjustments to the user equipment transmission power based on the data throughput. The scheduler preferably determines the adjustments to the user equipment modulation coding rate and the adjustments to the user equipment transmission power based on the data throughput by iteratively adjusting the value of the user equipment modulation coding rate and the user equipment transmission power. The base station preferably further comprises a throughput estimator estimating the data throughput of the up-link signal of the user equipment, and a user equipment command generator generating commands comprising the adjustments to the user equipment modulation coding rate and adjustments to the user equipment transmission power to the user equipment. The scheduler schedules the transmission of the commands to the user equipment.

In another aspect, the present invention provides a base station comprising a transceiver subsystem communicatively coupled to a network, the transceiver subsystem providing control signals for a user equipment modulation coding rate and a user equipment transmission power to user equipment. The base station preferably further comprises a controller determining adjustments to the user equipment modulation coding rate and adjustments to the user equipment transmission power, a power amplifier communicatively coupled to the transceiver subsystem, and one or more antennas communicatively coupled to the power amplifier, the antennas receiving up-link signals and transmitting down-link signals within a cell.

In a preferred embodiment, the controller receives a data throughput of the up-link signal of the user equipment, where the controller determines the adjustments of the user equipment modulation coding rate and the adjustments to the user equipment transmission power based on the data throughput. The controller preferably determines the adjustments to the user equipment modulation coding rate and adjustments to the user equipment transmission power based on the data throughput by iteratively adjusting the value of the user equipment modulation coding rate and the user equipment transmission power. The controller is preferably a hardware or software module within the transceiver subsystem. Alternatively, the controller may be a separate unit coupled to the transceiver subsystem.

In another aspect, the present invention provides a method for optimizing data throughput for a cell of a wireless network having a base station, user equipment, and an up-link relay. The method comprising receiving an up-link signal from user equipment by a base station and determining a data throughput of the up-link signal. The method further comprises determining an adjusted modulation coding rate and an adjusted transmission power for the user equipment based on the data throughput, and transmitting the adjusted modulation coding rate and the adjusted transmission power to the user equipment.

In a preferred embodiment, the method for optimizing data throughput for a cell of a network having a base station, user equipment, and an up-link relay as set out in claim 11, wherein determining the data throughput of the up-link signal further comprises estimating an expected number of transmissions needed to decode a data transport block, determining the current value of the modulation coding rate, and determining the data throughput of the up-link signal based on the expected number of transmissions per transport block and the current value of the modulation coding rate. The method preferably further comprises comparing the data throughput to products of predefined thresholds and a current value of the modulation coding rate. The determining an adjusted modulation coding rate and adjusted transmission power for the user equipment is preferably based on the comparison of the adjusted modulation coding rate and the products of predefined thresholds and a current value of the modulation coding rate. The method preferably further comprise comparing a current modulation coding rate to a maximum modulation coding rate, and selecting the transmission power that is less than a current transmission power when the current modulation coding rate is equal to the maximum modulation coding rate. The method preferably further comprises comparing a current modulation coding rate to a maximum modulation coding rate, and selecting the modulation coding rate that is greater than the current modulation coding rate when the current modulation coding rate is less than the maximum modulation coding rate. The method preferably further comprises comparing a current transmission power to a maximum transmission power, and selecting the modulation coding rate that is less than a current modulation coding rate when the current transmission power is equal to the maximum transmission power. The method preferably further comprises comparing a current transmission power to a value of a maximum transmission power, and selecting the transmission power that is greater than the current transmission power when the current transmission power is less than the maximum transmission power. The method preferably further comprises comparing a current transmission power to a value of a maximum transmission power, comparing a current data throughput with a previous data throughput, comparing a current modulation coding rate with a previous modulation coding rate, and selecting the modulation coding rate or the transmission power based on the comparisons of the current data throughput with a previous data throughput, and the current modulation coding rate with the previous modulation coding rate. The method preferably further comprises comparing a current transmission power to a maximum transmission power, comparing a current data throughput with a maximum data throughput, and selecting the modulation coding rate or the transmission power based on the comparisons of the current transmission power to the maximum transmission power and the current modulation coding rate with the previous modulation coding rate. The method preferably further comprises identifying an up-link signal assisted by the up-link relay, comparing the data throughput to products of modified predefined thresholds and a current value of the modulation coding rate. Determining an adjusted modulation coding rate and adjusted transmission power for the user equipment is preferably based on the comparison of the adjusted modulation coding rate and the products of modified predefined thresholds and a current value of the modulation coding rate.

Further features and aspects of the invention are set out in the following detailed description.

### BRIEF DESCRIPTION OF THE DRAWINGS

FIG. 1 is a representation of an evolved Node B (“eNB”) base station and user equipment (“UE”) for up-link and down-link communication.

FIG. 2 is a representation of up-link data transfers between the eNB, the UE, and the HARQ relay.

FIG. 3 is a representation of the data transfer sequence between the eNB, the UE, and the relay for up-link communication.

FIG. 4 is a representation of the data transfer sequence between the eNB, the UE, and for the up-link signals of an embodiment using the LTE release 10 UE.

FIG. 5 is a representation of transmission power as a function of distance between the mobile device and the base station for fair power and alternative power controls.

FIG. 6A is a representation of the data throughput as a function of UE position within a macro cell having no up-link relays.

FIG. 6B is a representation of the data throughput as a function of UE position within a macro cell employing eight relays and alternative power control.

FIG. 7 is a flow chart of an exemplary embodiment of an alternative algorithm for controlling the modulation rate R_{CQI} and the UE transmit power level Tx_{UE}.

FIG. 8 is a flow chart of an exemplary embodiment for a search algorithm for the modulation coding rate R_{CQI} with the highest throughput q.

FIG. 9 is a flow chart of a modified exemplary embodiment of an alternative algorithm that reduces the UE transmit power for relay-assisted UEs near the relay.

FIG. 10 is an exemplary system block diagram of a network having a base station, user equipment, and a relay in an embodiment of the invention.

### DETAILED DESCRIPTION OF THE INVENTION

Within a wireless communication network, a cell is defined by the coverage area of base station where it can communicate successfully with a mobile user over the radio frequency (“RF”) link. As shown in FIG. 1, within the Long Term Evolution standard (“LTE”), the base station and mobile user are referred to as the evolved Node B (“eNB”) 110 and user equipment (“UE”) 120, respectively. The eNB 110 transmits signals to the UE 120 through the down-link 103, and the UE 120 transmits signals to the eNB 110 through the up-link 102. A UE 120 operating near the cell edge 111 is subjected to an unfavorable RF link due to distance-dependent path losses to the eNB. As a result, cell-edge users often experience the lowest data throughput within the cell. LTE-Advanced (release 10), an enhancement of LTE (release 8), seeks to increase the data throughput for these cell-edge users using decode-and-forward relays. See S. Parkvall, D. Astely, “The evolution of LTE towards IMT-advanced,” J. Communications, vol 4, no. 3, pp. 146-154, 2009.

As used herein and consistent with well known terminology in the art, a repeater is an amplify-and-forward device which receives signals, amplifies the received signals, and re-transmits the signals within a defined bandwidth with minimal delay. A relay is a decode-and-forward device which receives signals, decodes the received signals, recodes the signals, and then transmits the recoded signals. Conventional repeaters are typically bi-directional devices which service both the up-link signals and the down-link signals. Likewise, conventional relays are also typically bi-directional devices which service both the up-link signals and the down-link signals. In contrast, embodiments described herein comprise a co-located up-link relay which services the up-link signals and a down-link repeater which services the down-link signals. Embodiments do not employ down-link relays but instead employ down-link repeaters.

Within this disclosure, the LTE specification will be used as a specific example of a preferred implementation of the invention. This, however, should not be taken as being limiting in nature.

The RAN1 working group within 3GPP is actively studying relays for LTE release 10. Two types of relays have been identified. The first type of relay, referred to as type 1, is a fully functioning eNB that performs its own scheduling and resource allocation. A wireless backhaul is used to transfer data to the host eNB which has wired access to the network and internet. In contrast, transparent relays, referred to as type 2 relays, are characterized by the reliance on the host eNB for scheduling and resource allocation. In this disclosure, only the up-link of the type 2 relay is considered.

A goal of the RAN1 working group is to specify a type 2 relay that improves the up-link data rate while being compatible with the existing LTE standard. The necessary coordination of transmission and reception for the relay is performed by the eNB scheduler using the Hybrid Automatic Repeat Request (“HARQ”) protocol, where the relay transmits only during HARQ retransmissions. The assistance provided by the relay improves the channel quality allowing for higher modulation coding rates to be used.

A transparent relay has been proposed for the up-link. See R1-082517, Nortel, “Transparent relay for LTE-A FDD,” RAN1 #53bis, Warsaw, Poland, June 2008. The up-link relay fits well into LTE because the up-link HARQ is synchronous, allowing the relay to predict when the retransmission from the UE will occur. That is, the HARQ-induced retransmission from the UE will always be 8 subframes (8 ms) after the initial UE transmission.

The RAN1 working group has concluded that a type 2 relay does not increase coverage. See R1-100951, ALU, ALU Shanghai Bell, CHTTL, “Type 2 relay summary,” RAN1 #60, San Francisco, Calif., February 2010. Instead it is best suited for increasing the capacity of the cell and improving the data throughput for edge users. This is due to the fact that only data, and not the control information, is relayed. For the case of the up-link, the relaying function need only be applied to the physical up-link shared channel (“PUSCH”) which carries the up-link data. The physical up-link control channel (“PUCCH”) and physical random access channel (“PRACH”) are not serviced by the relay and must be able to connect directly to the eNB. Thus, the PUCCH and PRACH range defines the coverage limits for the up-link.

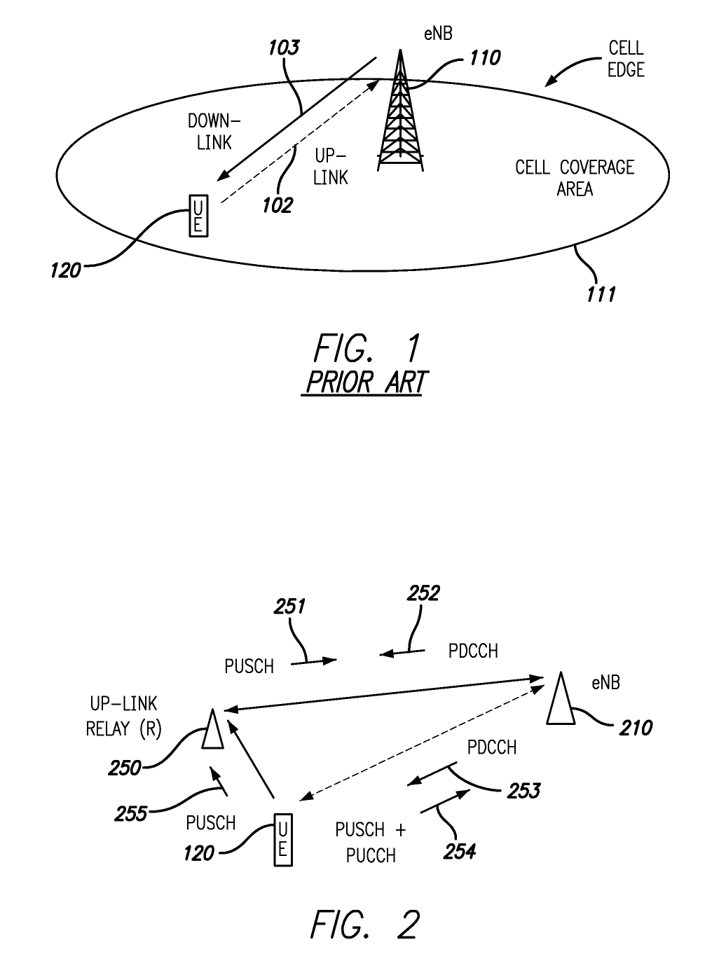

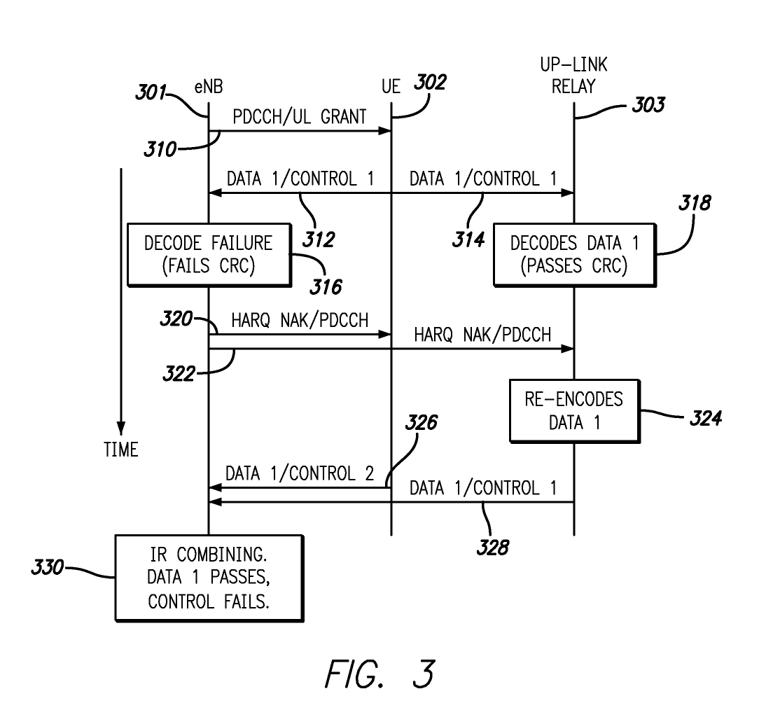

To facilitate an understanding of the invention, the data transfer between an eNB 210, the UE 120, and the relay 250 is shown in FIG. 2. The relay 250 demodulates UE transmissions, stores them briefly, and then recodes and retransmits if a HARQ request is made by the eNB 210. FIG. 2 also shows the PUSCH transmission 251 and physical down-link control channel (“PDCCH”) transmission 252 between the relay 250 and the eNB 210, and the PUSCH+PUCCH transmission 254 and the PDCCH transmission 253 between the eNB 210 and the UE 120.

An open issue with the up-link HARQ relay is how to treat the CQI/PMI, RI, and HARQ-ACK parameters, collectively referred to as the control signals, which are multiplexed on the original PUSCH, during a retransmission. The relay cannot predict the new control information from the UE.

To illustrate the problem, consider the data transfer sequence between the eNB 301, UE 302, and up-link relay 303, as shown in FIG. 3. Note that the control signals are not decoded correctly because the relay is transmitting out-dated control information during the HARQ retransmissions. The eNB 301 begins by sending an up-link grant on the PDCCH 310 to the UE 302. The UE 302 transmits data and control information 312 and 314 on the PUSCH which the eNB 301 receives and relay 303 receives and decodes at block 318. If the eNB 301 detects an error in the CRC at block 316, a retransmission is requested using the physical HARQ indicator channel (“PHICH”) and/or the PDCCH 320 and 322, which both the UE 302 and the relay 303 receive. See 3GPP, TS 36.213 v8.5.0., section 8. The UE 302 encodes and relay 303 encodes at block 324 the identical data for the HARQ retransmission, assuming the relay 303 decoded the originally transmitted UE signal correctly. Both the UE 302 and relay 303 retransmit on their PUSCH using the same up-link resources granted by the eNB scheduler via transmissions 326 and 328. The eNB 301 receives and decodes the combined UE/relay signal, then performs incremental redundancy (“IR”) combining with the first UE signal received to improve the accuracy of the decoding at block 330. The relay-assisted data will be decoded correctly by the eNB 301; however, the out-dated control information sent by the relay 303 will cause a decoding error for the received control signal.

Even if the relay decides not to transmit the control information, leaving the spaces in the PUSCH blank, problems still arise. See R1-093044, Huawei, “Issues of type 2 relay,” RAN1 #58, Shenzhen, China, August 2009. The up-link channel estimation uses the reference signals to measure the combined paths of the UE-to-eNB and the relay-to-eNB links. Blanking the control signals on the relay retransmission changes the up-link channel response. Thus, the data and control signals experience different channel responses; however, only one reference signal is provided. As a result, the reception of the control signals from the UE 302 will be blind. In summary, the type 2 up-link relay has to address the outstanding problem of how to deal with the control information multiplexed within the PUSCH.

The up-link modulation is enhanced for LTE release 10. The Single Carrier Frequency Division Multiple Access (“SC-FDMA”) used in release 8 is replaced by DFT-precoded OFDM, which is also known as clustered SC-FDMA. The resource block allocation for LTE release 10 permits the simultaneous transmission of the PUCCH and PUSCH in the same sub-frame by a UE. See section 6.3 in 3GPP, TR 36.814 v9.0.0. This is exploited in the exemplary embodiments. The key difference from the RAN1 proposals is that the up-link control signals transmitted by a relay-assisted UE appear on the PUCCH during the HARQ retransmissions. Out-dated control information multiplexed on the PUSCH transmitted by the up-link relay is ignored.

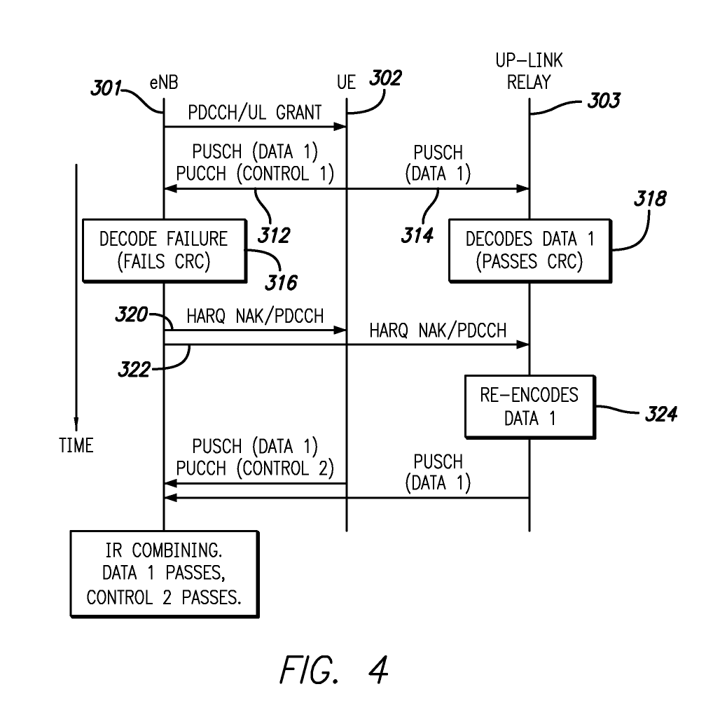

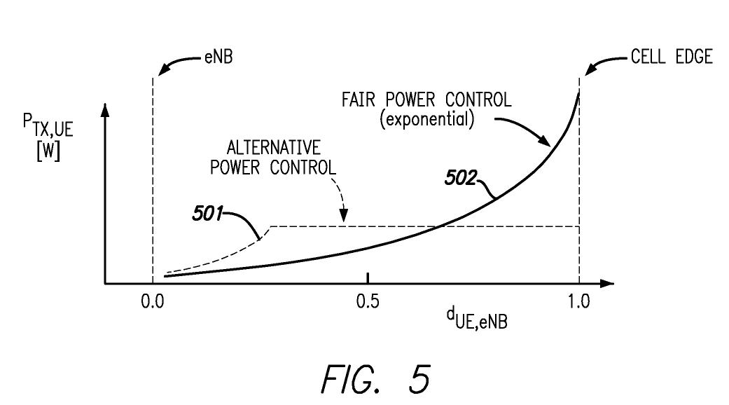

LTE release 10 has simplified the operation of the uplink relay. By sending the control information separately on the PUCCH, as shown in FIG. 4, instead of multiplexing it onto the PUSCH, the most current control information is always sent by the UE 302. Note that the UE transmits control information on the PUCCH and data on the PUSCH while the relay is transmitting data only on the PUSCH to the eNB. Since the modulation coding scheme used for the PUCCH is more robust, it is likely that the control information will be decoded correctly even when the data is not. As a result, control information, such as the channel quality (“CQI”), is being fed back to the eNB scheduler in a timely manner.

The throughput is analyzed for up-link relays assisting release 10 compatible UEs that are capable of simultaneous transmissions of the PUSCH and PUCCH.

The up-link data rate that can be supported is dependent on the signal-to-noise ratio (“SNR”) of the transmitted UE signal measured at the eNB or relay receiver. The required SNRs for QPSK 1/3 (i.e., QPSK utilizing 1/3 coding rate), 16-QAM 3/4 (i.e., Quadrature amplitude modulation—16 constellation points (4×4)), and 64-QAM 5/6 (i.e., Quadrature amplitude modulation—64 constellation points (8×8)) modulation coding rates with a fractional throughput of 70% are specified in as −0.4 dB, 11.5 dB, and 19.7 dB, respectively. See 3GPP, TS 36.104 v8.3.0., Table 8.2.1.1-6. Assumptions include a 20 MHz bandwidth, the receiver having two antennas, and the propagation condition is modeled using the extended pedestrian A (5 Hz). See 3GPP, TS 36.104 v8.3.0. The HARQ retransmissions reduce the fractional throughput by increasing the average number of transmissions per transport block. A 70% throughput corresponds to 1.43 transmissions per transport block on average. For a fractional throughput of 30%, the average number of transmissions is 3.33 and the required SNR for QPSK 1/3, as specified is −4.2 dB. See 3GPP, TS 36.104 v8.3.0.

The expected number of transmissions per transport block, without relay assistance, is

$${E [ n ]}_{no \_ relay} = {\sum }_{n = 1}^{4} {p}_{n} \cdot n = \frac{1}{β} \qquad ( 1 )$$

where β is the fractional throughput for the UE-to-eNB link and pₙ is the probability that n transmissions are made for a given transport block. The probabilities pₙ are modeled as

pₙ=β·(1−β)ⁿ⁻¹, (2)

which is a simplification that does not account for the improvement in the SNR as n increases, due to the IR (incremental redundancy) combining used in the HARQ process. However, the approximation is reasonable for β≧0.7.

Now consider the case of relay assistance. Assume that the UE is transmitting the PUSCH and PUCCH simultaneously and the assistance of the HARQ relay guarantees that no additional retransmissions are needed (if the relay decodes the previous UE transmission correctly). The expected number of transmissions when the relay is used becomes

$$\begin{matrix}E [ n ] = β + ( 1 - β ) \cdot {\sum }_{n = 2}^{4} γ \cdot {( 1 - γ )}^{n - 2} \cdot n \\ where & ( 3 ) \\ γ = ρ + ( 1 - ρ ) \cdot β & ( 4 )\end{matrix}$$

and ρ is the fractional throughput for the UE-to-relay link. As in the previous case, the model described by (3) does not account for the SNR improvement for n≧2 due to IR combining. However, it is a reasonable approximation when either β or ρ is large enough that E[n]<2.

Let us establish a RF channel model. The distance-dependent path loss (L) is modeled as

L=128.5+37.2·log₁₀(d) (5)

where d is the distance in km from the transmitter to receiver. The antenna gains for the eNB, relay, and UE are assumed to be 15 dB, 5 dB, and 0 dB, respectively. The building penetration losses for UE and relay transmissions are assumed to be 15 dB and 0 dB, respectively. The relay-to-eNB link is 20 dB better than the UE-to-eNB link due to differences in the antenna gain and penetration losses. As a result, it is assumed that limits to the up-link data rate are due to the UE-to-eNB and UE-to-relay links only.

An approximation of the effective up-link data rate (the number of decoded bits per symbol transmitted) as a function of receiver SNR is provided in S. Sesia, I. Toufik, and M. Baker, LTE—The UMTS Long Term Evolution: From Theory to Practice, UK: Wiley, 2009, eq. 20.3 as

R_{data}=k⁻¹·log₂(1+SNR) (6)

where k is a discount factor representing the practical limitations in the receiver. The effective data rates for a 70% fractional throughput of QPSK 1/3, 16-QAM 3/4, and 64-QAM 5/6 are η=0.47, 2.1, and 3.5 (70% of ⅔, 3, and 5), which correspond to k=2.00, 1.87, and 1.87, respectively. For a fractional throughput of 30%, the effective data rate of QPSK 1/3 is η=0.2 and k=2.32. In order to make (6) fit the SNR values specified in 3GPP, TS 36.104 v8.3.0, we make

k=1.87·[1+0.05·SNR⁻¹]. (7)

Note that k=1 corresponds to the Shannon limit.

In the following it is assumed that the noise powers measured by the receivers in the eNB and relay are the same. Thus, the SNRs at the eNB and relay receivers are functions of their antenna gains and path losses from the UE:

$$\begin{matrix}{SNR}_{UE , relay} = {SNR}_{UE , eNB} \cdot {G}_{relay} \cdot {G}_{eNB}^{- 1} \cdot {α}^{- 3.72} \\ where & ( 8 ) \\ α = [ \frac{{d}_{UE , relay}}{{d}_{UE , eNB}} ] & ( 9 )\end{matrix}$$

and SNR_{UE,relay} and SNR_{UE,eNB} are the SNRs for the UE signal at the relay and eNB receivers, respectively; d_{UE,relay} and d_{UE,eNB} are the distances from the UE to the relay and to the eNB, respectively; and G_{relay} and G_{eNB} are the antenna gains for the relay and eNB. Note that (8) ignores shadowing.

The position of the relay relative to the UE and eNB affects the throughput performance. Consider three cases: α=[0.50 0.33 0.25]. The SNRs and data rates supported (R_{data}) for the UE-to-relay and UE-to-eNB links are listed in Table I, under the assumption that the power transmitted by the UE is such that SNR_{UE,eNB}=−0.4 dB. The SNR and data rate supported, based on (6), increase as the distance between the UE and relay decreases (lower α).

TABLE I
SNR and supportable up-link data rates (using (6))

| | UE-relay | UE-relay | UE-relay | |
|---|---|---|---|---|
| | α = 0.50 | α = 0.33 | α = 0.25 | UE-eNB |
| Rx SNR | 1.2 dB | 7.8 dB | 12.4 dB | −0.4 dB |
| R_{data} | 0.58 | 1.49 | 2.24 | 0.47 |

Table II shows the data throughput η and the average number of transmissions per transport block, E[n], for the unassisted up-link and relay-assisted up-link for α=[0.50 0.33 0.25]. The available modulation coding rates for the LTE up-link are indicated by a CQI index that increases with the modulation code rate. See 3GPP, TS 36.213 v8.5.0, Table 7.2.3-1. β is ratio of the supported data rate based on (6) and the CQI modulation coding rate for the UE-to-eNB link: that is,

$$β = \frac{{R}_{data ( eNB )}}{{R}_{CQI}} \qquad ( 10 )$$

where R_{data(eNB)} is the supported data rate for the UE-to-eNB link (see Table I) and R_{CQI} denotes the modulation coding rate for the selected CQI index. See 3GPP, TS 36.213 v8.5.0, Table 7.2.3-1. ρ is the lesser of unity and the ratio for the UE-to-relay link: that is,

$$ρ = min \{ \frac{{R}_{data ( relay )}}{{R}_{CQI}} , 1.0 \} \qquad ( 11 )$$

where R_{data(relay)} is the supported data rate for the UE-to-relay link (see Table I). The selected modulation coding rate is the maximum value for which E[n]<2 and the probability of more than four transmissions, denoted by P(n>4), is less than 0.01. The data throughput is

$$η = \frac{{R}_{CQI}}{E [ n ]} . \qquad ( 12 )$$

From Table II it can be seen that the relay assistance increases the throughput η as well as the average number of transmissions per transport block, E[n]. Smaller values of α result in higher throughputs. The largest throughput of the cases considered, occurring for α=0.25, is η=1.39, which is an improvement by a factor of 2.96 over the no-relay case. Reducing α below 0.25 provides limited incremental improvement because the higher CQI modulation coding rates needed may exceed R_{data} for the relay-to-eNB link, resulting in additional retransmissions not modeled in (3).

TABLE II
Relay assisted uplink performance (throughput η)

| | CQI | R_{CQI} | E [n] | η | β | ρ |
|---|---|---|---|---|---|---|
| No relay | 4 | 0.602 | 1.28 | 0.47 | 0.78 | 0.00 |
| α = 0.50 | 5 | 0.877 | 1.56 | 0.56 | 0.53 | 0.66 |
| α = 0.33 | 8 | 1.914 | 1.91 | 1.00 | 0.24 | 0.78 |
| α = 0.25 | 10 | 2.731 | 1.97 | 1.39 | 0.17 | 0.82 |

The analysis performed above relies on the ability of (2) and (3) to model the IR-HARQ process. The model accuracy is sufficient as long as most of the transport blocks are received successfully by the eNB on either the first or second transmission. This is the motivation for selecting the CQI index such that E[n]<2 and P(n>4)<0.01. However, there are cases where a cell-edge UE experiences a poor channel requiring several HARQ retransmissions per transport block to allow the incremental redundancy (IR) combining to raise the received SNR high enough. An example is discussed where the fractional throughput is 30% (E[n]=3.33). See 3GPP, TS 36.104 v8.3.0. For these cases, observations regarding relay assistance must be made without using (2) and (3).

Up to this point, it has been assumed that each UE is transmitting at a power level sufficient for the SNR at the eNB receiver to be −0.4 dB without relay assistance. When the power control is operated to achieve equal received SNR, the power transmitted by each UE 120 is a function of the distance to the eNB and is inversely proportional to the path loss defined by (5), as shown in FIG. 5. This is often referred to as “fair” power control as depicted by curve 502. The fair power control adjusts the UE transmit power so that the SNR of the up-link signal received by the eNB is the same for all UEs. The most noticeable feature is that UEs at the cell edge are transmitting at the highest power level. In the following, the distance between the UE 120 and eNB, denoted by d_{UE,eNB}, is measured as a fraction of the macro cell radius. That is, d_{UE,eNB}=1 for a UE at the cell edge.

Fair power control means that each UE such as UE 120 has the same data throughput (R_{data}=0.47 decoded bits per symbol). However, relay assistance increases the throughput of some of the UEs above this target throughput. If higher throughputs are allowed for relay-assisted UEs, it is preferable to also assign higher throughputs to UEs close to the eNB that have a favorable channel without relay assistance. As a result, an alternative form of power control is provided which allows UEs near the eNB to use higher modulation coding rates.

In an embodiment of this alternative power control scheme, every UE such as UE 120 is assigned a maximum transmit power and a maximum modulation coding rate. Fair power control is applied only when the maximum modulation coding rate is achieved. As a result, only the UEs close to the eNB will transmit at a lower power level than the maximum allowed. The power transmitted by each UE with this alternative approach, as a function of the distance to the eNB, is also shown as curve 501 in FIG. 5.

A simulation may be used to estimate the average throughput within the macro cell using this alternative power control scheme in an embodiment, with and without relay assistance. The optimal CQI index, in terms of the maximum throughput, is determined at each location within the macro cell. It is assumed that the CQI coding rate will be successful if the SNR is high enough that the data rate transmitted is less than the capacity of the channel (R_{CQI}<R_{data}. See 3GPP, TS 36.213 v8.5.0, Table 7.2.3-1, and (6)). It is assumed that the HARQ retransmission increases the effective SNR at the receiver to N_{HARQ}*SNR, where N_{HARQ} is the number of transmissions needed to make R_{data}>R_{CQI}. Thus, every CQI index will be successful if retransmitted often enough. However, the effective throughput is R_{CQI}/N_{HARQ} when there is no relay assistance so higher CQI codes do not necessarily result in higher throughputs. The CQI index with the highest effective throughput is selected.

When the relay assistance is considered, the effective throughput to the eNB is R_{CQI}/(N_{HARQ}+1), where the additional transmission is due to the relay-to-eNB transmission. Every CQI index is tested using the nearest relay and the index with the highest effective throughput is retained. The path with the largest throughput, either direct to the eNB or through the available relays such as relay 250, is selected as the throughput for that location within the macro cell. Thus, the relative position of the UE 120 to the eNB and the relays determines its effective data throughput in this simulation.

The simulation measures the average throughput of the cell and the average throughput of UEs in the outer ring defined by 0.5<d_{UE,eNB}<1.0. The throughputs are computed for different numbers of relays. The relays are located at a distance of d_{UE,eNB}=0.7 and are spaced equally around the outer ring. The maximum transmit power for the UE is selected so that CQI=4 is successful at a distance d_{UE,eNB}=0.65. The maximum coding rate allowed is CQI=10. Without relay assistance, the average throughput for the entire macro cell is Rₐᵥₑ=0.74 bits/symbol. The average throughput within the outer ring is Rₐᵥₑ=0.36 bits/symbol, when no relay assistance is given. When N_{relay} relays are added, the average throughput for the cell increases to Rₐᵥₑ=0.044*N_{relay}+0.74. The average throughput for outer ring becomes Rₐᵥₑ=0.059*N_{relay}+0.36. This approximation is valid for N_{relay}≦8, above which the incremental improvement is less due to overlap of the relay service areas.

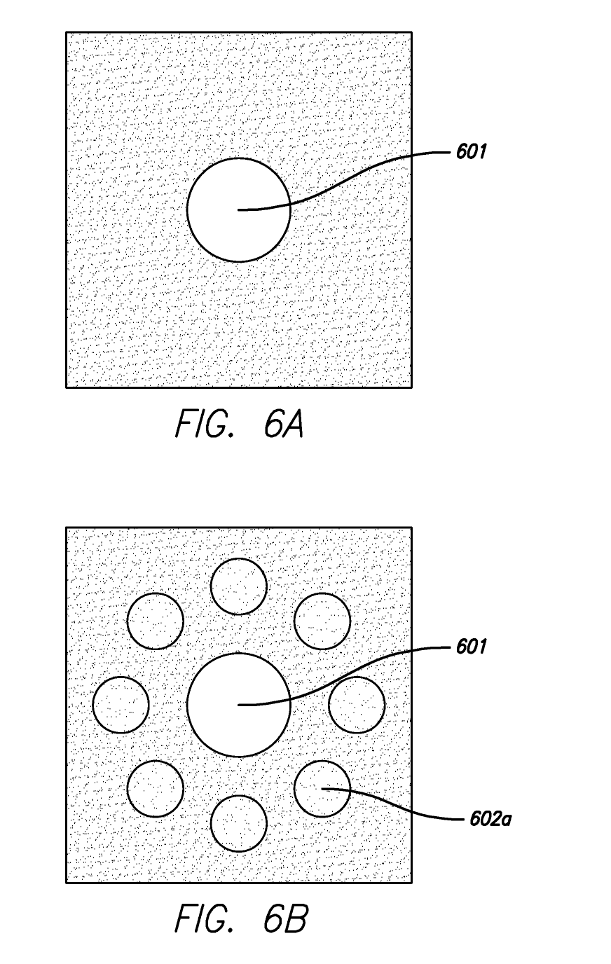

The throughput for each UE location within the macro cell is shown in FIGS. 6A and 6B for the cases of 0 and 8 relays respectively. The eNB is located at the center of the macro cell. Note that lighter colors denote higher throughputs. The high throughput locations for UEs connected directly to the eNB are depicted as region 601, and the high throughput locations for UEs assisted by the relays are depicted by 602a. Adding relays improves the average throughput significantly. The relays are equally-spaced at a distance of 0.7 from the eNB. For N_{relay}=8, the average throughput for the cell and outer ring increase by a factor of 1.48 and 2.31, respectively. However, there are some edge users that are not within the service area of one of the relays. Such UEs may wish to increase their transmitted power to raise their throughput.

The number of transmissions per transport block, averaged over the entire macro cell, is E[n]=1.17 when no relay assistance is given. The addition of 8 relays increases the average number of transmissions to E[n]=1.86. Within the outer ring (0.5<d_{UE,eNB}<1.0), the average number of transmissions per transport block for the no relay and 8 relay cases are E[n]=1.23 and 2.14, respectively. Thus, the average delay per transport block is increased by the relay assistance.

This alternative power control approach is applied to the PUSCH only. The PUCCH is still transmitted at levels based on the fair power control to ensure that the PUCCH can communicate directly with the eNB from anywhere within the macro cell.

Type 2 relays have been proposed as a means of improving the up-link data throughput for UEs near the cell edge in a LTE network. Improving the up-link data throughput for the entire cell serviced by the eNB 110 is also important. This is achieved by the eNB scheduler when it optimizes the UE transmit power control and selection of modulation coding rate based on the measured throughput. Optimizing throughput using the alternative power control mentioned earlier is described below in more detail.

The eNB selects the modulation coding rate (“R_{CQI}”) and the transmit power (“Tx_{UE}”) for the UE 120. (An expanded block diagram of the eNB is shown in FIG. 10). This information is generated as part of the eNB scheduler and is sent to the UE over the PDCCH. In one or more embodiments, the selection of R_{CQI} and Tx_{UE} are limited by predetermined maximum values. In general, UEs near the eNB will transmit using the maximum R_{CQI} at a power level sufficient to achieve a targeted throughput. UEs far from the eNB will transmit at the maximum power Tx_{UE} using the R_{CQI} that maximizes the throughput η. Thus, this algorithm relies on the estimation of the UL throughput η to generate R_{CQI} and Tx_{UE} in an optimal manner.

As mentioned earlier in (12), the up-link throughput n is determined by the modulation coding rate R_{CQI} and the expected number of transmissions (E[n]) required to decode a transport block successfully. Since R_{CQI} is selected by the eNB, the determination of E[n] for a given R_{CQI} is important. This is done by counting the number of transmissions needed for the eNB to receive and decode N transport blocks then computing the average number of transmissions per transport block (E[n]).

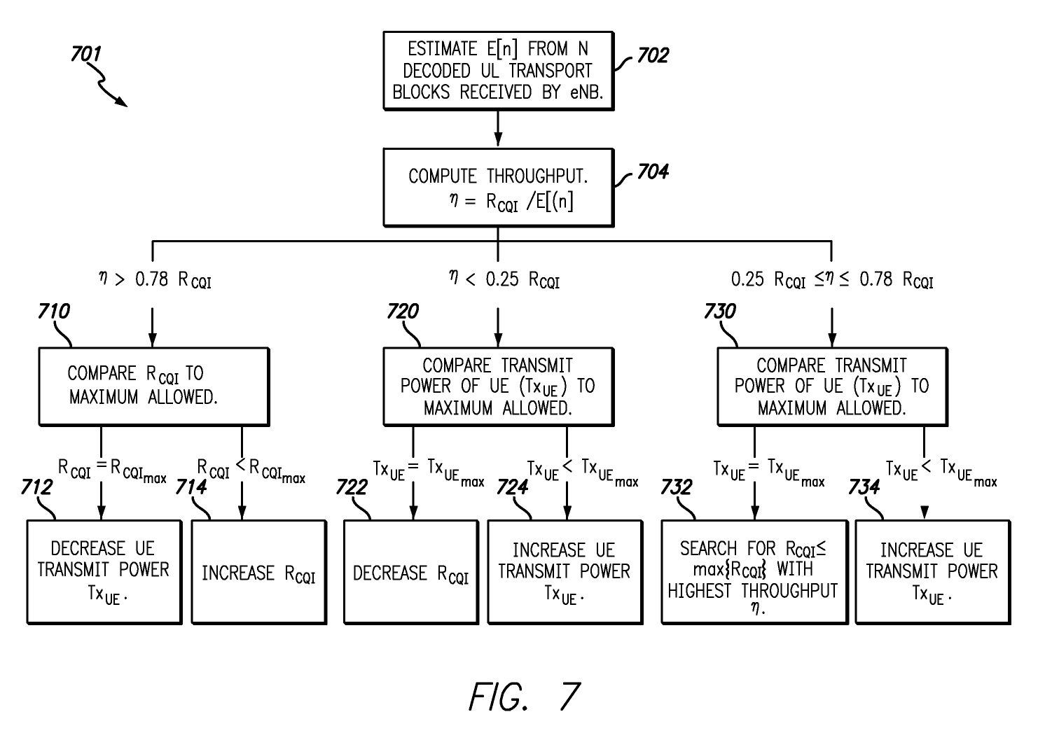

An exemplary power control algorithm 701 is shown in FIG. 7. It is a search algorithm where the R_{CQI} is incremented or decremented (by a specified offset in terms of the CQI index) to find the maximum throughput for a given power level, or Tx_{UE} is incremented or decremented (by a specified dB value) to minimize the power transmitted while maintaining a targeted data throughput. E[n] is estimated from N decoded UL transport blocks received by the eNB (step 702). The throughput η is computed based on the R_{CQI} and E[n] (step 704). Based on the measured throughput η, the R_{CQI} and Tx_{UE} are adjusted. If the throughput η is high relative to the selected R_{CQI} (η>0.78 R_{CQI}), the expected number of transmissions per transport block is close to unity (E[n]<1.28). This indicates that the channel quality is higher than needed for an optimal trade-off of data throughput and power use. In such cases, R_{CQI} is compared to the maximum R_{CQI} (step 710). The modulation coding rate R_{CQI} is increased if the present R_{CQI} is less than the maximum allowed (step 714), or the UE transmit power Tx_{UE} is reduced if the present R_{CQI} is equal to the maximum allowed (step 712). If the throughput η is low relative to the selected R_{CQI} (η<0.25 R_{CQI}), the expected number of transmissions per transport block is high (E[n]>4). This indicates that the channel quality is lower than needed for an optimal trade-off of data throughput and power use. In such cases, the transmit power of the UE is compared to the maximum transmit power (step 720). The modulation coding rate R_{CQI} is decreased if the present UE transmit power Tx_{UE} is equal to the maximum allowed (step 722), or the UE transmit power Tx_{UE} is increased if the present UE transmit power Tx_{UE} is less than the maximum allowed (step 724).

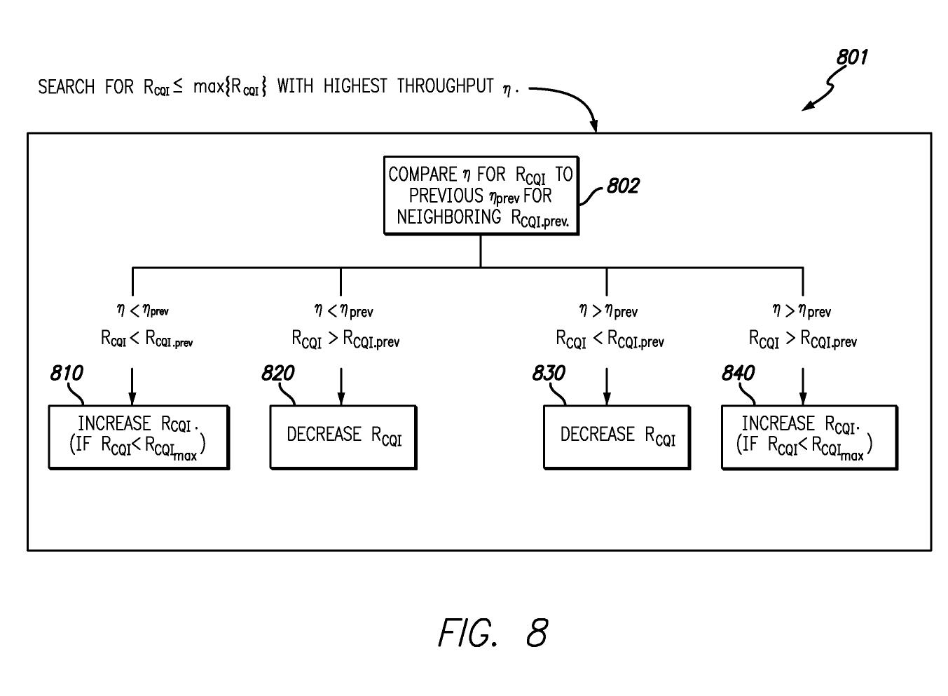

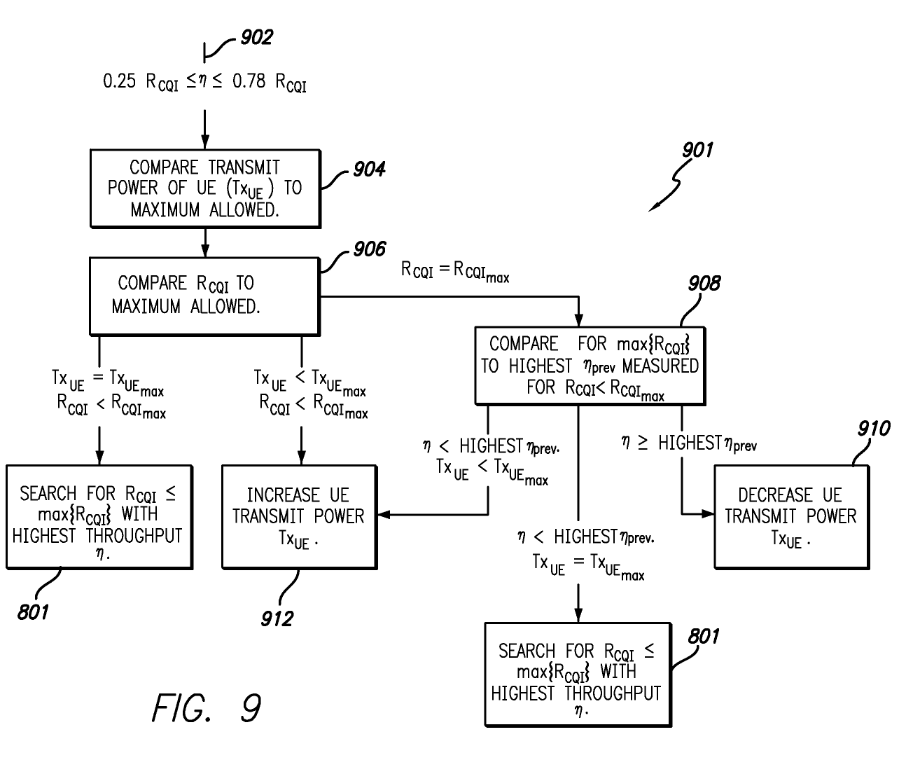

The intermediate case occurs when the throughput η lies between the thresholds mentioned above (0.25 R_{CQI}≦η≦0.78 R_{CQI}). In such cases, the transmit power of the UE is compared to the maximum transmit power (step 730). If the UE transmit power Tx_{UE} is below the maximum allowed, the Tx_{UE} is increased (step 734). If the UE transmit power Tx_{UE} is equal to the maximum allowed, a search for the R_{CQI} producing the highest throughput η is initiated (step 732). One implementation of the search for the R_{CQI} with the largest throughput η (up to the maximum R_{CQI}) is shown as method 801 in FIG. 8. The throughput η for the present R_{CQI} is compared with previous throughput values (ηₚᵣₑᵥ) estimated using previous R_{CQI} values (R_{CQI,prev}) (step 802). If the present throughput η is lower than the previous value, a new R_{CQI} is selected. If R_{CQI}<R_{CQI,prev}, then the new R_{CQI} is increased (step 810) above R_{CQI,prev} if possible, or if R_{CQI}>R_{CQI,prev}, then the new R_{CQI} is decreased (step 820) below R_{CQI,prev}. If the present throughput η is higher than the previous value, a new R_{CQI} is selected. If R_{CQI}<R_{CQI,prev}, then the new R_{CQI} is decreased (step 830), or if R_{CQI}>R_{CQI,prev}, then the new R_{CQI} is increased (step 840) if possible.

The search shown in FIG. 8 is made more complicated by the fact that the curve describing the throughput η as a function of R_{CQI} may have many local minima. This is due to the fact that the number of transmissions per transport block, n, is an integer. It may be necessary to randomize the increment/decrement offset used to adjust R_{CQI} to avoid becoming trapped in a local minimum that is not the global minimum. However, the expected value of the number of transmissions per transport block, E[n], can have non-integer values when averaged over N transmissions (N>>1). This averaging will tend to reduce the likelihood of undesired local minima in the throughput n as a function of R_{CQI}.

The exemplary embodiments shown in FIG. 7 and FIG. 8 can be used for controlling R_{CQI} and Tx_{UE} for either UEs communicating directly to the eNB or with the assistance of the relay. The algorithm, however, may be modified to address a potential short-coming. UEs that are being assisted by a relay will always transmit at the maximum power (because E[n]≧2 and η≦0.5 R_{CQI}). When the UE is close to a relay, its transmission can desensitize the relay's receiver causing UEs further from the relay to be dropped and forced to communicate directly with the eNB. In some cases this may be undesirable.

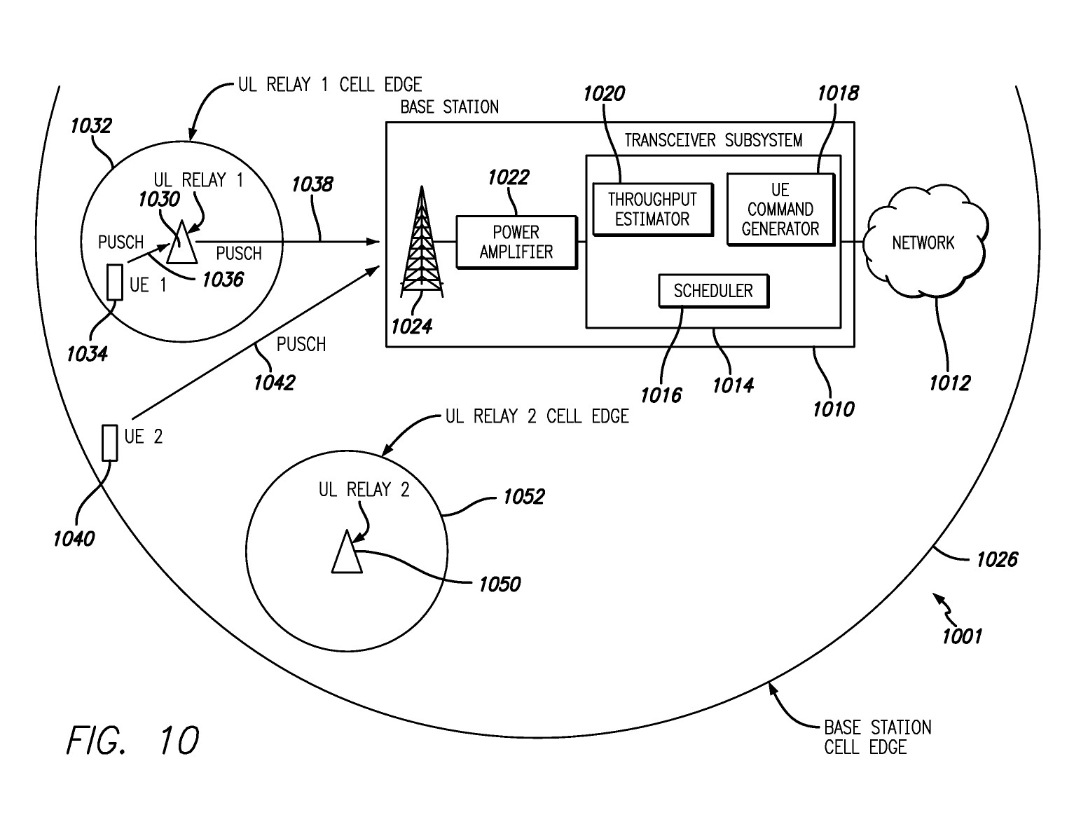

The alternative power control 901 can be modified, as shown in FIG. 9, to provide power control that benefits the relay receiver. The intermediate case (0.25 R_{CQI}≦η≦0.78 R_{CQI} 902) is altered so that the UE transmit power is reduced when the maximum R_{CQI} is used. The transmit power of the UE is compared with the maximum transmit power (step 904). The R_{CQI} is compared to the maximum R_{CQI} allowed (step 906). If the maximum R_{CQI} is being used, the throughput q is measured and compared to the highest ηₚᵣₑᵥ measured at lower R_{CQI} values (step 908). If the present n is greater than the highest ηₚᵣₑᵥ, the UE transmit power Tx_{UE} is reduced (step 910). If the present n is less than the highest ηₚᵣₑᵥ and Tx_{UE} is less than the maximum allowed, the UE transmit power Tx_{UE} is increased (step 912). If the present n is less than the highest ηₚᵣₑᵥ and Tx_{UE} is equal to the maximum allowed, the search 801 in FIG. 8 is initiated. This algorithm reduces the power transmitted by UEs near a relay, as desired.

If the maximum R_{CQI} is not being used, and if the transmit power of the UE is equal to the maximum transmit power, a search for the R_{CQI} with the highest throughput is performed (step 801). If the UE transmit power is less than the maximum transmit power, the UE transmit power is increased (step 912).

The highest ηₚᵣₑᵥ measured at lower R_{CQI} values, described above, represents a target throughput for controlling the UE transmit power Tx_{UE}. It is possible to use a replacement target throughput that is a discounted value (say, 0.8) of the throughput measured using the maximum R_{CQI} and the maximum Tx_{UE}.

Power control suitable for a relay-assisted UE can be implemented using FIG. 7 and FIG. 8, by changing the throughput thresholds. If a UE is identified as being relay-assisted, the upper threshold can be reduced to account for the additional transmission per transport block (for example, the threshold η>0.78 R_{CQI} in FIG. 7 would be reduced to η>0.44 R_{CQI}). Relay-assisted UEs can be identified by the distribution of n. That is, a transport block from a relay-assisted UE will be decoded rarely by the eNB on the first transmission and frequently on the second transmission. Alternatively, the relay-assisted UE can be identified by a low SNR for the first transmission received by the eNB and a high SNR for subsequent retransmissions.

FIG. 10 is an exemplary system block diagram of a network having a base station, user equipment, and a relay in an embodiment of the invention. The system 1001 has a eNB base station 1010 having a base station cell edge 1026, a first up-link relay 1030 and a second up-link relay 1050 having cell edges 1032 and 1052 respectively, and a first UE 1034 and a second UE 1040. The eNB base station 1010 comprises a transceiver subsystem 1014 coupled with a network 1012, a power amplifier 1022, and an antenna 1024. The transceiver subsystem 1014 comprises a throughput estimator 1020, a UE command generator 1018, and a scheduler 1016. The throughput estimator 1020 and the UE command generator 1018 may be integral with the transceiver subsystem 1014 or may be a separate control unit in an embodiment. Also, these may be implemented as modified or separate software modules which are part of the transceiver subsystem.

The first UE 1034 is within the first up-link relay cell 1032 and transmits up-link signals to the eNB base station 1010 via the up-link relay 1030 via signals 1036 and 1038. The second UE 1040 transmits up-link signals directly to the eNB base station 1010 via signal 1042.

The present invention has been described primarily as a system and method for improving data throughput for cell edge users in a network employing an alternative power control. In this regard, the system and methods for improving data throughput are presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

### DEFINITIONS

For the purposes of the present disclosure, the abbreviations given in TR 21.905 apply. See S. Sesia, I. Toufik, and M. Baker, LTE—The UMTS Long Term Evolution: From Theory to Practice, UK: Wiley, 2009. An abbreviation defined in the present disclosure takes precedence over the definition of the same abbreviation, if any, in TR 21.905.

RAN1: http://www.3gpp.org/RAN1-Radio-layer-1
CQI/PMI: channel quality indication (CQI), precoding matrix indicator (PMI)
RI: Rank indicator

### HARQ-ACK: Hybrid Automatic Repeat Request (HARQ), ACKnowledgement

SC-FDMA: Single-carrier FDMA (SC-FDMA) is a frequency-division multiple access scheme
QPSK1/3: QPSK utilizing 1/3 coding rate
16-QAM 3/4: Quadrature amplitude modulation—16 constellation points (4×4)
64-QAM 5/6: Quadrature amplitude modulation—64 constellation points (8×8)
IR-HARQ: Incremental redundancy—Hybrid Automatic Repeat Request

### ACK: Acknowledgement

### BCH: Broadcast Channel

### CCPCH: Common Control Physical Channel

### CQI: Channel Quality Indicator

### CRC: Cyclic Redundancy Check

### DL: Downlink

### DTX: Discontinuous Transmission

### eNB: Evolved Node B

### EPRE: Energy Per Resource Element

### LTE: Long Term Evolution

### NACK: Negative Acknowledgement

PCFICH: Physical control format indicator channel 3GPP Release 8T 7 3GPP TS 36.213 V8.0.0 (2007-09)

### PDSCH: Physical Downlink Shared Channel

### PHICH: Physical Hybrid ARQ Indicator Channel

PRACH: Physical random access channel

### PUCCH: Physical Uplink Control Channel

### PUSCH: Physical Uplink Shared Channel

### QoS: Quality of Service

### RE: Resource Element

### RPF: Repetition Factor

### RS: Reference Signal

### SC-FDMA: Single Carrier Frequency Division Multiple Access

### SIR: Signal-to-Interference Ratio

SINR: Signal to Interference plus Noise Ratio

### SNR: Signal to Noise Ratio

TA: Time alignment

### TTI: Transmission Time Interval

### UE: User Equipment

UL: Uplink

What is claimed is:

1. A wireless communication system, comprising:
a base station communicating within a cell, the base station controlling resource allocation for up-link and down-link signals; and,
user equipment located within the cell, the user equipment transmitting and receiving signals;
wherein the base station determines a data throughput of the up-link signal of the user equipment and determines a user equipment modulation coding rate and a user equipment transmission power and transmits adjustments to the user equipment modulation coding rate and adjustments to the user equipment transmission power to the user equipment based on the data throughput.

2. The wireless communication system as set out in claim 1, further comprising:
an up-link relay receiving the up-link signals, decoding the received up-link signals, recoding the decoded up-link signals, and re-transmitting the recoded up-link signals.

3. The wireless communication system as set out in claim 2, wherein the base station comprises a scheduler for determining the data throughput of the up-link signal of the user equipment, wherein the scheduler determines the adjustments to the user equipment modulation coding rate and the adjustments to the user equipment transmission power based on the data throughput.

4. The wireless communication system as set out in claim 3, wherein the scheduler determines the adjustments to the user equipment modulation coding rate and the adjustments to the user equipment transmission power based on the data throughput by iteratively adjusting the value of the user equipment modulation coding rate and the user equipment transmission power.

5. The wireless communication system as set out in claim 3, wherein the base station further comprises:
a throughput estimator estimating the data throughput of the up-link signal of the user equipment;
a user equipment command generator generating commands comprising the adjustments to the user equipment modulation coding rate and adjustments to the user equipment transmission power to the user equipment; and,
wherein the scheduler schedules the transmission of the commands to the user equipment.

6. A base station, comprising:
a transceiver subsystem communicatively coupled to a network, the transceiver subsystem providing control signals for a user equipment modulation coding rate and a user equipment transmission power to user equipment;
a controller determining adjustments to the user equipment modulation coding rate and adjustments to the user equipment transmission power;
a power amplifier communicatively coupled to the transceiver subsystem; and,
one or more antennas communicatively coupled to the power amplifier, the antenna receiving up-link signals and transmitting down-link signals within a cell.

7. The base station as set out in claim 6, wherein the controller receives a data throughput of the up-link signal of the user equipment, wherein the controller determines the adjustments of the user equipment modulation coding rate and the adjustments to the user equipment transmission power based on the data throughput.

8. The base station as set out in claim 7, wherein the controller determines the adjustments to the user equipment modulation coding rate and adjustments to the user equipment transmission power based on the data throughput by iteratively adjusting the value of the user equipment modulation coding rate and the user equipment transmission power.

9. The base station as set out in claim 6, wherein the controller is a hardware or software module within the transceiver subsystem.

10. The base station as set out in claim 6, wherein the controller is a separate unit coupled to the transceiver subsystem.

11. A method for optimizing data throughput for a cell of a wireless network having a base station, user equipment, and an up-link relay, comprising:
receiving an up-link signal from user equipment by a base station;
determining a data throughput of the up-link signal;
determining an adjusted modulation coding rate and an adjusted transmission power for the user equipment based on the data throughput; and,
transmitting the adjusted modulation coding rate and the adjusted transmission power to the user equipment.

12. The method for optimizing data throughput for a cell of a wireless network having a base station, user equipment, and an up-link relay as set out in claim 11, wherein determining the data throughput of the up-link signal further comprises:
estimating an expected number of transmissions needed to decode a data transport block;
determining the current value of the modulation coding rate; and,
determining the data throughput of the up-link signal based on the expected number of transmissions per transport block and the current value of the modulation coding rate.

13. The method for optimizing data throughput for a cell of a wireless network having a base station, user equipment, and an up-link relay as set out in claim 12, further comprising:
comparing the data throughput to products of predefined thresholds and a current value of the modulation coding rate;
wherein determining an adjusted modulation coding rate and adjusted transmission power for the user equipment is based on the comparison of the adjusted modulation coding rate and the products of predefined thresholds and a current value of the modulation coding rate.

14. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current modulation coding rate to a maximum modulation coding rate; and,
selecting the transmission power that is less than a current transmission power when the current modulation coding rate is equal to the maximum modulation coding rate.

15. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current modulation coding rate to a maximum modulation coding rate;
selecting the modulation coding rate that is greater than the current modulation coding rate when the current modulation coding rate is less than the maximum modulation coding rate.

16. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current transmission power to a maximum transmission power; and,
selecting the modulation coding rate that is less than a current modulation coding rate when the current transmission power is equal to the maximum transmission power.

17. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current transmission power to a value of a maximum transmission power; and,
selecting the transmission power that is greater than the current transmission power when the current transmission power is less than the maximum transmission power.

18. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current transmission power to a value of a maximum transmission power;
comparing a current data throughput with a previous data throughput,
comparing a current modulation coding rate with a previous modulation coding rate;
selecting the modulation coding rate or the transmission power based on the comparisons of the current data throughput with a previous data throughput, and the current modulation coding rate with the previous modulation coding rate.

19. The method for optimizing data throughput for a cell of a wireless network having a base station, user equipment, and an up-link relay as set out in claim 12, wherein determining the adjusted modulation coding rate and the adjusted transmission power for the user equipment further comprises:
comparing a current transmission power to a maximum transmission power;
comparing a current data throughput with a maximum data throughput,
selecting the modulation coding rate or the transmission power based on the comparisons of the current transmission power to the maximum transmission power and the current modulation coding rate with the previous modulation coding rate.

20. The method for optimizing data throughput for a cell of a wireless network having a base station, user equipment, and an up-link relay as set out in claim 12 further comprising:
identifying an up-link signal assisted by the up-link relay;
comparing the data throughput to products of modified predefined thresholds and a current value of the modulation coding rate;
wherein determining an adjusted modulation coding rate and adjusted transmission power for the user equipment is based on the comparison of the adjusted modulation coding rate and the products of modified predefined thresholds and a current value of the modulation coding rate.
